(19) United States
(12) Patent Application Publication
(10) Pub. No.: US 2019/0134832 A1
(43) Pub. Date: May 9, 2019

(54) HAIR CUTTING SHEARS

(71) Applicant: William Robert SMITH, Franklin, TN (US)

(72) Inventor: William Robert SMITH, Franklin, TN (US)

(21) Appl. No.: 15/981,282

(22) Filed: May 16, 2018

Related U.S. Application Data
(60) Provisional application No. 62/507,458, filed on May 17, 2017.

(51) Int. Cl. B26B 13/24; B26B 21/12

(52) U.S. Cl. CPC B26B 13/24; B26B 13/20; B26B 21/12

(57) ABSTRACT

The present invention provides methods and systems for a pair of hair cutting shears that includes two pivotally connected shear blades, consisting of a first blade and a second blade, wherein a razor may extend across the first blade and the second blade contains an engagement device, for receiving a comb for selectively securing the comb within the engagement device.

### CROSS REFERENCE TO RELATED PATENT APPLICATION

The present patent application/patent claims the benefit of priority of co-pending U.S. Provisional Patent Application No. 62/507,458, filed on May 17, 2017, and entitled “HAIR CUTTING SHEARS,” the contents of which are incorporated in full by reference herein.

### FIELD OF THE INVENTION

The present invention relates generally to hair cutting shears having a first blade and a second blade, and more generally relates to hair cutting shears having a razor, and specifically a texturizing razor, engaged to a first blade, and a comb selectively secured or engaged to a second blade.

### BACKGROUND OF THE INVENTION

This invention relates to hair cutting shears used by barbers, stylists, cosmetologists, and the like. When an individual is cutting hair, they generally hold the hair cutting shears in one hand and the comb in the other hand to remove the hair. As they cut the hair with one hand, they have to use the other hand to comb and remove the hair. It is an object of the present invention to include a selectively secured comb to the hair cutting shear for ease of use by the barber or stylists and a texturizing razor, allowing the shears to have two hair trimming/cutting options.

The object of the present invention is to remove the need to exchange the shears and comb while cutting hair. With the comb engaged to the shears, there is no need to cut and then exchange the shears for the comb to comb the hair. The present invention allows the haircut motion to move through more smoothly and deliver a more precise cut.

### BRIEF SUMMARY OF THE INVENTION

According to an embodiment of the present invention, hair cutting shears include two pivotally connected shear blades, consisting of a first blade and a second blade, wherein a razor is engaged to the first blade and the second blade contains an engagement device, for receiving a comb for selectively securing the comb within the engagement device.

According to yet another embodiment of the present invention, the hair cutting shears contain an engagement device composed of metal.

According to yet another embodiment of the present invention, the hair cutting shears contain an engagement device composed of plastic.

According to yet another embodiment of the present invention, the hair cutting shears contain a texturizing razor.

According to yet another embodiment of the present invention, the hair cutting shears include an engagement device that has a trough with a base extending to a first outer edge and a second outer edge, a first side extends upwardly from the first outer edge and a second side extends upwardly from the second outer edge.

According to yet another embodiment of the present invention, the hair cutting shears include at least two pivotally connected shear blades including a first blade and a second blade, the first blade comprises a first end, a second end, a first side, a second side, an interior side, and an exterior side and the second blade comprises a first end, a second end, a first side, a second side, an interior side, and an exterior side, wherein a razor may extend across the exterior side of the first blade and engaged to the exterior side of the second blade is a trough, for receiving a comb for selectively securing the comb to the second blade.

According to yet another embodiment of the present invention, the hair cutting shears include a guard selectively secured to the razor.

According to yet another embodiment of the present invention, the hair cutting shears include two pivotally connected shear blades, consisting of a first blade and a second blade, the first blade comprises a first end, a second end, a first side, a second side, an interior side, and an exterior side and the second blade comprises a first end, a second end, a first side, a second side, an interior side, and an exterior side, wherein the second side of the first blade is a razor and the second side of the second blade contains a plurality of teeth extending therefrom.

### BRIEF DESCRIPTION OF THE DRAWINGS

The present invention is illustrated and described herein with reference to the various drawings, in which like reference numbers denote like method steps and/or system components, respectively, and in which:

FIG. 1 is a perspective view of hair cutting shears of the present invention;

FIG. 2 is a perspective view of the hair cutting shears of the present invention;

FIG. 3 is a perspective view of the hair cutting shears with the comb removed;

FIG. 4 is another perspective view of the hair cutting shears with the comb removed;

FIG. 5 is an alternative embodiment of the hair cutting shears of the present invention;

FIG. 6 is a perspective view of the engagement device; and

FIG. 7 is a perspective view of the guard.

### DETAILED DESCRIPTION OF THE INVENTION

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

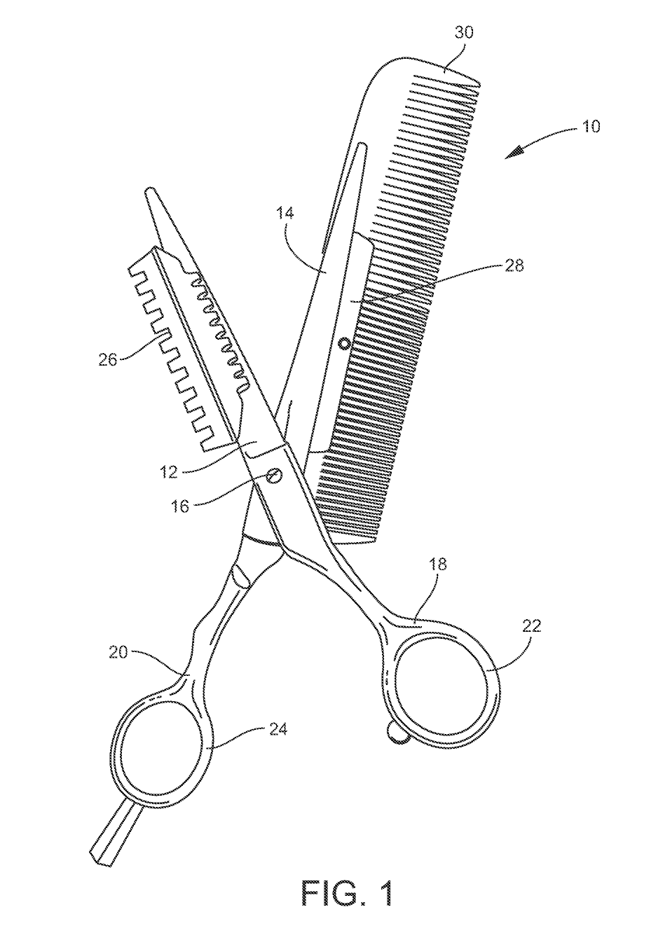

Referring now specifically to the drawings, a pair of hair cutting shears are illustrated in FIGS. 1-5 and shown generally at reference numeral 10. The shears consist of a first blade 12 and a second blade 14 that are pivotally connected by a pin 16. The blades (12,14) include integral handle portions, including a first handle 18 and a second handle 20. The handles (18, 20) have generally circular finger rings, including a first finger ring 22 on the first handle 18 and a second finger ring 24 on the second handle 20. The inner side of the finger rings 22 and 24 may contain a rubber portion for providing comfort and stability to the user's fingers. The rubber portion is engaged to the inside surface of the finger rings (22,24) and may cover the entire inside surface or just a portion of the inside surface.

The first blade 12 includes a texturizing razer 26 and the second blade 14 contains an engagement device 28 for receiving a comb 30. The first blade 12 includes a first end, a second end, a first side, a second side, an interior side, and an exterior side. The first end of the first blade 12 is opposite the first handle 18 and may be pointed. The second end is adjacent the pin 16. The first side contains a sharp edge for cutting hair, and the second side contains the texturizing razer 26 engaged thereto, which may extend outwardly from the second side of the first blade 12. Alternatively, the razer 26 may be integral with the exterior side of the first blade 12, so as not to interfere with the cutting action of the first side and extend past and outwardly from the second side. The second blade 14 includes a first end, a second end, a first side, a second side, an interior side, and an exterior side. The first end of the second blade 14 is opposite the second handle 20 and may be pointed. The second end is adjacent the pin 16. The first side contains a sharp edge for cutting hair, and the second side contains the engagement device 28. Alternatively, the exterior side of the second blade 14 may contain the engagement device 28 and the comb 30 extends past and outwardly from the second side. Alternatively, the exterior side of the second blade 14 may contain a comb 30 engaged thereto.

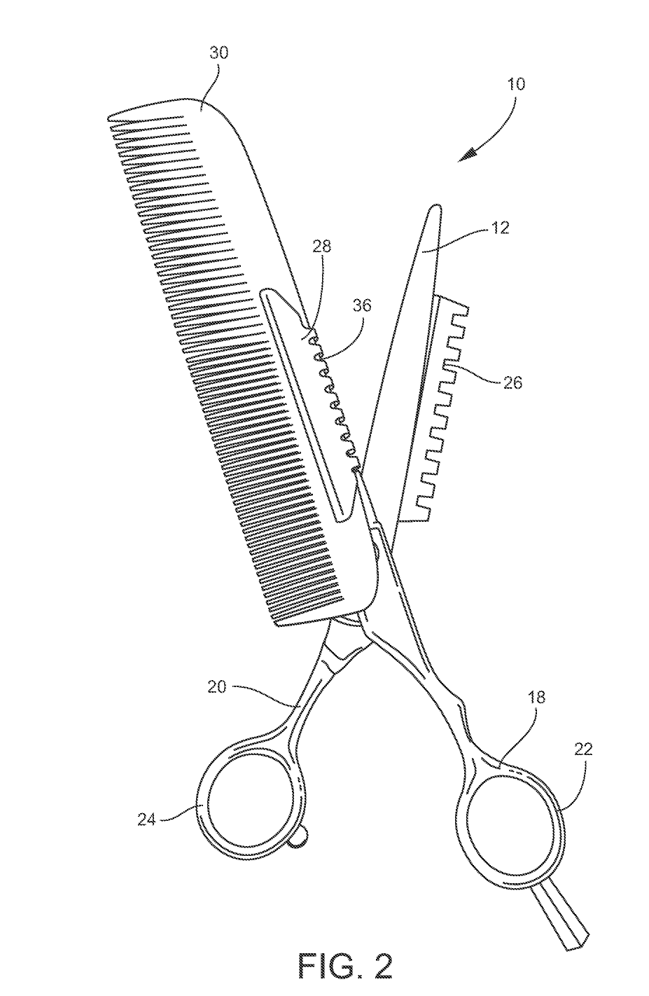

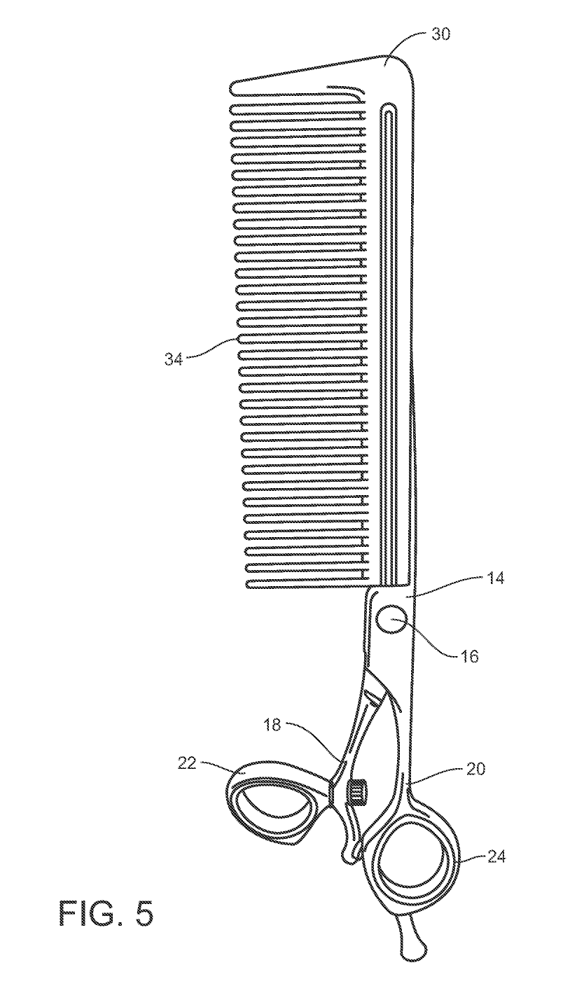

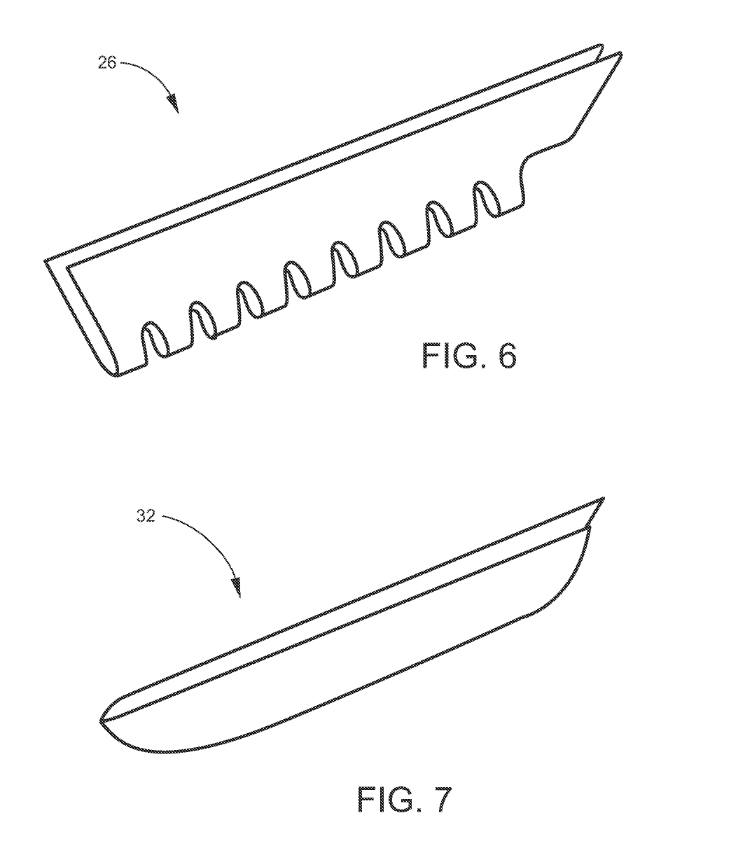

The shears 10 have an open position and a closed position. In the open position, as shown in FIGS. 1-2, the first handle 18 and second handle 20 are spaced apart. Likewise, the first blade 12 and second blade 14 are spaced apart. In the closed position, as illustrated in FIG. 5, a portion of the first handle 18 contacts a portion of the second handle 20, and the interior side of the first blade 12 is adjacent the interior side of the second blade 14.

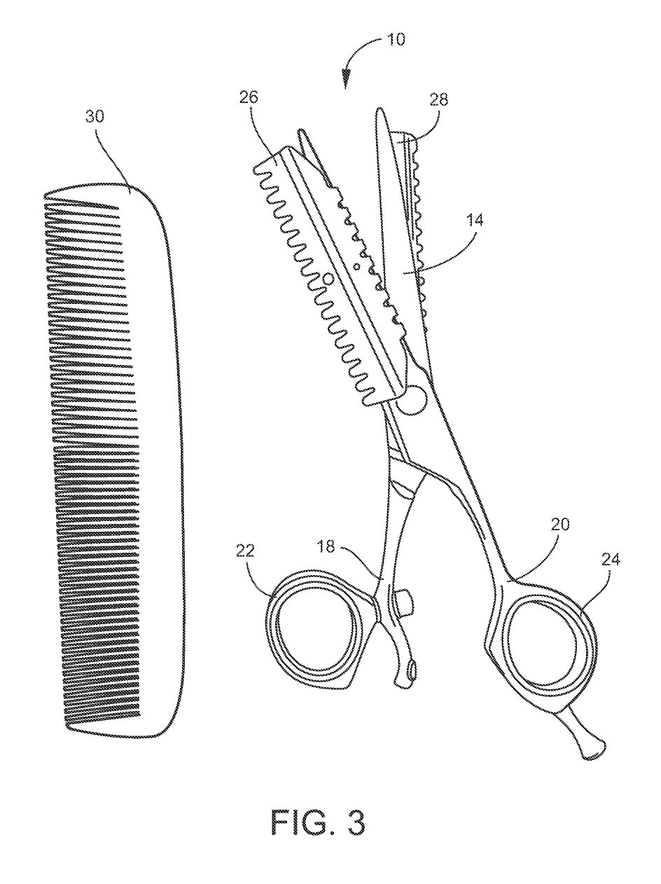

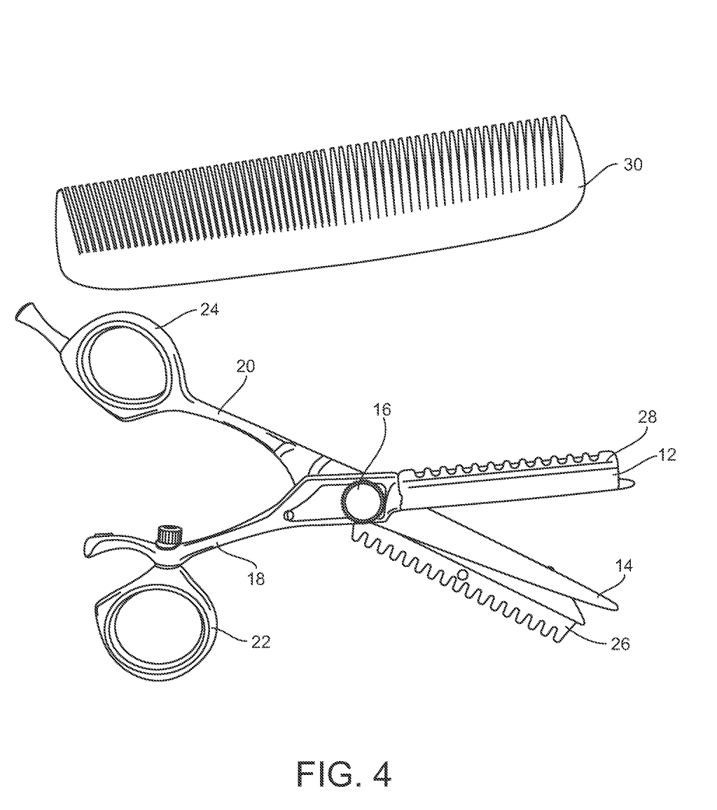

The texturizing razor 26 preferably extends the full length of the first blade 12 and extends outwards from the first blade 12, as shown in FIGS. 3-4, so as not to interfere with the cutting action of the first side of the first blade 12 and the second blade 14. However, the texturizing razor 26 may only extend along a portion of the length of the first blade 12, as shown in FIGS. 1-2. The texturizing razor may optionally extend to a point. A guard 32, as shown in FIG. 7, may be selectively secured to the razor 26 or an area around the razor 26, so that the razor 26 only cuts a predetermined length of hair. The guard 32 is detachable, allowing for different sized guards 32 to be selectively secured for cutting different predetermined lengths of hair. Selectively secured means the guard 32 is not integral with the razer 26, but can be removed and replaced on the razer 26 by the user.

The engagement device 28, as shown in FIG. 7, is engaged to the second blade 12, also preferably extends the full width of the blade 14. As illustrated in FIG. 2, the engagement device 28 is disposed on the external side of the second blade 14 and extends outwardly from the second blade 14, so as not to interfere with the cutting action of the first side of the first blade 12 and the second blade 14. The engagement device 28 may consist of a trough. The trough has a base that extends outwards to an outer edge on each side of the trough. A first side extends upwardly from one side of the outer edge, and a second side extends upwardly from the other side of the outer edge. Alternatively, the external side of the second blade 14 serves as a second side of the trough. The back portion of the comb 30 is slide within the trough with the teeth of the comb extending outwardly from the engagement device 28. The comb 30 is selectively secured to the engagement device 28 by friction fit, allowing the comb 30 to be easily removed and replaced within the engagement device 28. As shown in FIG. 2, the base of the engagement device 28 may have a plurality of voids that extends from the interior side to the exterior side of the engagement device.

The engagement device 28 may also be a spring-loaded clip, wherein a side of the clip is engaged to the exterior side of the second blade 14. A spring is engaged to a side of the clip and the exterior side of the second blade 14. During use, the side of the clip is pivoted backwards and the back portion of the comb is inserted into the clip. The side is released, causing the side to spring forward towards the exterior side of the second blade 14. The comb 30 is selectively secured within the clip and can only be removed by forcing the clip open.

In another alternative embodiment, the second side of the first blade 12 is a razor 26. This embodiment is slightly different than the embodiment illustrated in FIGS. 1-4, wherein the razor 26 is integral with the first blade 12. Likewise, as illustrated in FIG. 5, the second side of the second blade 14 contains a plurality of teeth 34 extending therefrom.

In another alternative embodiment, the engagement mechanism 28 may be a bar allowing the comb 30 to be selectively secured and allowed to slide on and off the bar. The bar is cast as part of the blade 14 or engaged to the blade 14 and solid with the blade 14.

The present invention may also be contained within a kit, meaning a pair of hair cutting shears 10 is included with two or more combs 30 and/or two or more razors 26 and/or guards 32 for being selectively secured to the shears 10.

The shears 10 are preferably composed of metal, including the first blade 12 and the second blade 14. The engagement device 28 may be composed of metal or plastic.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. Hair cutting shears, comprising:
two pivotally connected shear blades, consisting of a first blade and a second blade, wherein the second blade contains an engagement device for receiving a comb for selectively securing the comb within the engagement device.

2. A pair of hair cutting shears according to claim 1, further comprising a razor engaged to the first blade.

3. A pair of hair cutting shears according to claim 1, wherein the engagement device is a trough comprising a base extending to a first outer edge and a second outer edge, a first side extends upwardly from the first outer edge and a second side extends upwardly from the second outer edge.

4. A pair of hair cutting shears according to claim 1, wherein the engagement device is composed of metal.

5. A pair of hair cutting shears according to claim 1, wherein the engagement device is composed of plastic.

6. Hair cutting shears, comprising:
two pivotally connected shear blades, consisting of a first blade and a second blade, the first blade comprises a first end, a second end, a first side, a second side, an interior side, and an exterior side and the second blade comprises a first end, a second end, a first side, a second side, an interior side, and an exterior side, wherein a razor may extend across the exterior side of the first blade and engaged to the exterior side of the second blade is a trough, for receiving a comb for selectively securing the comb to the second blade.

7. A pair of hair cutting shears according to claim 6, further comprising a guard selectively secured to the razor.

8. A pair of hair cutting shears according to claim 6, wherein the razor is a texturizing razor.

9. A pair of hair cutting shears according to claim 6, wherein the engagement device is a trough comprising a base extending to a first outer edge and a second outer edge, a first side extends upwardly from the first outer edge and a second side extends upwardly from the second outer edge.

10. A pair of hair cutting shears according to claim 6, wherein the engagement device is composed of metal.

11. A pair of hair cutting shears according to claim 6, wherein the engagement device is composed of plastic.

12. Hair cutting shears, comprising:
two pivotally connected shear blades, consisting of a first blade and a second blade, the first blade comprises a first end, a second end, a first side, a second side, an interior side, and an exterior side and the second blade comprises a first end, a second end, a first side, a second side, an interior side, and an exterior side, wherein the second side of the first blade is a razor and the second side of the second blade contains a plurality of teeth extending therefrom.

13. A pair of hair cutting shears according to claim 12, further comprising a guard selectively secured to the razor.

14. A pair of hair cutting shears according to claim 12, wherein the razor is a texturizing razor.
